(19) United States
(12) Patent Application Publication
(10) Pub. No.: US 2024/0169351 A1
(43) Pub. Date: May 23, 2024

(54) INFORMATION PROCESSING APPARATUS, INFORMATION PROCESSING SYSTEM, AND INFORMATION PROCESSING METHOD

(71) Applicant: Toshiba Tec Kabushiki Kaisha, Tokyo (JP)

(72) Inventor: Masachika KURATA, Sunto Shizuoka (JP)

(21) Appl. No.: 18/366,657

(22) Filed: Aug. 7, 2023

(30) Foreign Application Priority Data
Nov. 17, 2022 (JP) 2022-183916

(51) Int. Cl. G06Q 20/40; G06Q 20/20; G06V 20/52; G06V 40/20

(52) U.S. Cl. CPC G06Q 20/4016; G06Q 20/20; G06V 20/52; G06V 40/20

(57) ABSTRACT

An information processing apparatus for retail store systems includes a communication interface connected to a camera to acquire video of a POS terminal and an operator of the POS terminal. A processor is configured to detect suspected fraud behavior at the POS terminal based on image analysis of the acquired video, generate a first notification indicating a type of detected suspected fraud behavior with an image of the suspected fraud behavior, then output the generated first notification via the communication interface to a display unit. The processor also generates a second notification including a video clip extracted from the video at a time point corresponding to the suspected fraud behavior and outputs the second notification via the communication interface to the display unit after the first notification.

### CROSS-REFERENCE TO RELATED APPLICATION

This application is based upon and claims the benefit of priority from Japanese Patent Application No. 2022-183916, filed Nov. 17, 2022, the entire contents of which are incorporated herein by reference.

### FIELD

Embodiments described herein relate to an information processing apparatus, an information processing system, and an information processing method for self-service type point-of-sale systems.

### BACKGROUND

In the related art, a self-service-type point of sales (POS) terminal allows a shopper to perform registration and settlement of merchandise and a semi-self-service-type POS terminal allows the shopper to perform the settlement after the merchandise registration has been performed by a salesclerk. A technique of notifying store staff of occurrences of incidents, such as not registering merchandise or payment trouble, at the POS terminal is known.

For example, the store staff member who receives a notification can determine whether to take measures such as calling out to the shopper. Under these circumstances, the notification requires sufficient content for the store staff to identify the necessity of a possible measure to be performed, such a video clip from a monitoring camera. On the other hand, when time after the occurrence of the incident is required to provide the notification, there is a risk of missing the time or chance for taking a measure such as calling out to the customer.

### BRIEF DESCRIPTION OF THE DRAWINGS

FIG. 1 is a diagram showing an example of a configuration of a point of sales (POS) system according to an embodiment.

FIG. 2 is a perspective view showing an example of a self-service POS terminal according to an embodiment as viewed from an operator side.

FIG. 3 is a diagram of a hardware configuration of a self-service POS terminal.

FIG. 4 is a diagram of a hardware configuration of an attendant terminal according to an embodiment.

FIG. 5 is a diagram of a hardware configuration of a server apparatus according to an embodiment.

FIG. 6 is a diagram of functional aspects of a self-service POS terminal.

FIG. 7 is a diagram of functional aspects of an attendant terminal.

FIG. 8 is a diagram of functional aspects of a server apparatus.

FIG. 9 is a sequence diagram showing an example of a flow of information processing executed in a POS system.

FIG. 10 is a diagram of a display screen displayed in information processing.

### DETAILED DESCRIPTION

In general, according to one embodiment, occurrence of an incident on a POS terminal can be appropriately notified to store personnel or the like.

An information processing apparatus for retail store systems includes a communication interface connected to a camera positioned to acquire video of a POS terminal and an operation position for an operator of the POS terminal. The apparatus additionally has a processor configured to detect suspected fraud behavior of the operator at the POS terminal based on image analysis of the acquired video and generate a first notification indicating a type of detected suspected fraud behavior and including an image related to the suspected fraud behavior. The image is extracted from the acquired video at a time point corresponding the detected suspected fraud behavior. The processor outputs the generated first notification via the communication interface to a display unit. The processor also generates a second notification including a video clip extracted from the acquired video at the time point corresponding to the detected suspected fraud behavior and then outputs the second notification via the communication interface to the display unit after the first notification. In general, the first notification may act as an initial alert to an attendant, store clerk or the like so that the attendant, store clerk or the like may receive notice as soon as possible after detection of suspected fraud. The second notification provides additional information as follow up for confirmation of the detection of the suspected fraud was not in error or the like.

Hereinafter, an information processing apparatus, an information processing system, and an information processing method for a point-of-sale system will be described with reference to the drawings.

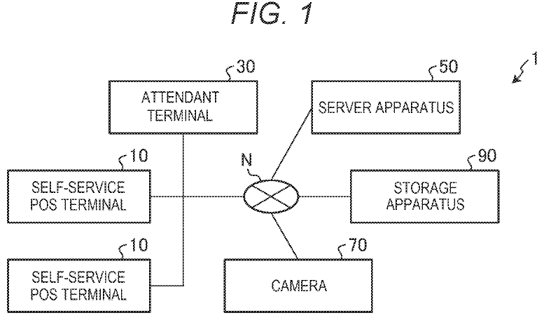

FIG. 1 is a diagram showing an example of a configuration of a point-of-sales (POS) system 1 according to an embodiment. As shown in FIG. 1, the POS system 1 includes self-service POS terminals 10, an attendant terminal 30, a server apparatus 50, a camera 70, and a storage apparatus 90. In the POS system 1, the self-service POS terminals 10, the attendant terminal 30, the server apparatus 50, the camera 70, and the storage apparatus 90 are communicably connected to one another via a network N in a wired or wireless manner. Here, the POS system 1 according to the embodiment is an example of an information processing system.

The self-service POS terminal 10 is a self-service-type POS terminal that performs registration and settlement of merchandise with a shopper serving as the operator. The self-service POS terminal 10 is an example of a sales data processing apparatus that executes a merchandise registration process of registering merchandise to be sold and a payment process for the merchandise registered by the merchandise registration process by an operation of a customer.

The attendant terminal 30 is a terminal device used by a salesclerk. The salesclerk may be referred to as an attendant. The attendant (salesclerk) manages and monitors a self-service POS terminal group including at least one self-service POS terminal 10 and helps customers who operate these self-service POS terminals 10 when necessary. The attendant terminal 30 is, for example, a personal computer, a tablet terminal, or a smartphone. The attendant terminal 30 is connected to the plurality of self-service POS terminals 10. In some examples, any self-service POS terminal 10 among the plurality of self-service POS terminals 10 connected to one another via the network N can also be used as the attendant terminal 30. The attendant terminal 30 notifies the salesclerk of detection of suspected fraud behavior based on notification information from the server apparatus 50. Here, the attendant terminal 30 according to the embodiment is an example of a display unit.

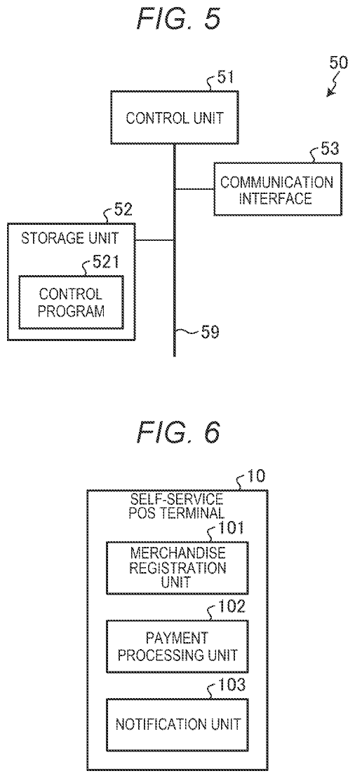

The server apparatus 50 is installed in a backroom of a store or the like. The server apparatus 50 is also referred to as a store server. The server apparatus 50 is an example of an image processing apparatus that performs image processing on video from the camera 70 that images a self-service POS terminal 10. The server apparatus 50 is an example of an information processing apparatus that performs detection of the suspected fraud behavior by using the video. The server apparatus 50 is an example of an information processing apparatus that performs notification by notifying the attendant terminal 30 of event information along with, in some instances, a relevant image (thumbnail) as simple (simplified) information, and also generates a moving image (video clip) to be transmitted to the attendant terminal 30 as detailed information when suspected fraud behavior is detected. A PLU file distributed to the self-service POS terminal 10 is stored in a storage unit 52 (see FIG. 5) of the server apparatus 50. Here, the server apparatus 50 is an example of an information processing apparatus.

A camera 70 is disposed, in this example, for each self-service POS terminal 10, but in other examples may be disposed for two or more self-service POS terminals 10 as a group. In still other examples, a plurality of cameras 70 may be disposed for each self-service POS terminal 10. The camera 70 includes an imaging element such as a complementary metal-oxide semiconductor (CMOS) or a charge coupled device (CCD). The camera 70 outputs data of the imaged video to the storage apparatus 90.

The storage apparatus 90 is implemented as, for example, a network storage device. As an example, the storage apparatus 90 includes a storage unit such as a hard disk drive (HDD), a solid-state drive (SSD), or a flash memory, a control circuit that controls writing into and reading from the storage unit, and a communication circuit for communicating with outside. The storage apparatus 90 stores the video data from the camera 70. The storage apparatus 90 stores images or moving images cut out (clipped) from the video by the server apparatus 50.

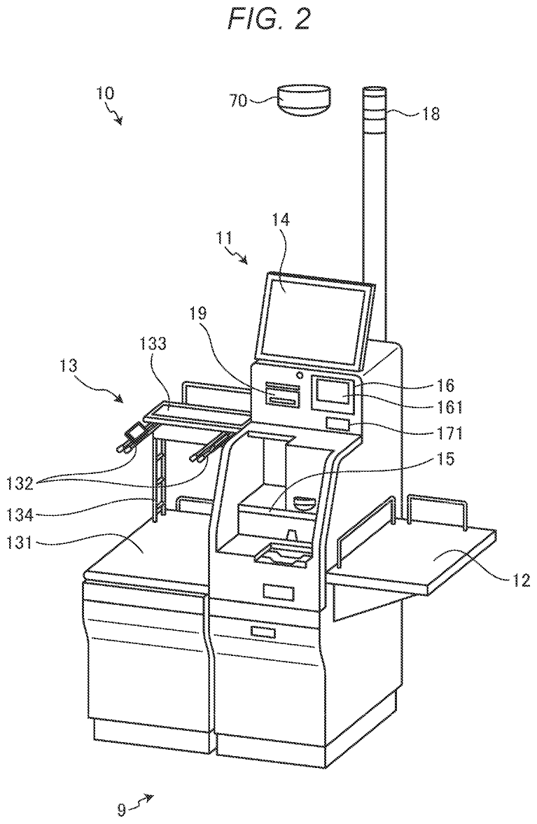

FIG. 2 is a perspective view showing an example of an appearance of the self-service POS terminal as viewed from an operator side. As shown in FIG. 2, the self-service POS terminal 10 includes a main body 11, a basket placement table 12, and a bagging table 13.

The main body 11 is provided between the basket placement table 12 and the bagging table 13. The basket placement table 12 is an object placement table where a basket can be placed during merchandise registration. The bagging table 13 is an object placement table where a shopping bag can be hooked in an open state. Registered merchandise is put in the shopping bag or otherwise placed on the bagging table 13.

The bagging table 13 includes a base 131, bag hooks 132, and a temporary placement table 133. The bag hooks 132 and the temporary placement table 133 are supported by a support column 134 provided on the base 131. The base 131 is, for example, a table where merchandise or the like not suitable for being put into a bag such as merchandise larger than the bag can be placed. The bag hook 132 is a hook for hanging a bag into which registered merchandise is put. The temporary placement table 133 is, for example, a table where merchandise that requires attention in bagging such as fragile merchandise can be temporarily placed.

As shown in FIG. 2, the camera 70 is disposed so as to be able to perform imaging in an imaging range including the self-service POS terminal 10 and an operation position 9 thereof. Here, the imaging range including the operation position 9 is a range in which an operator (user) of the self-service POS terminal 10 can be imaged. That is, according to a video obtained in the imaging range including the operation position 9, the operator of the self-service POS terminal 10 and presence or absence of the operator can be determined. Further, the imaging range including the self-service POS terminal 10 is a range in which at least the basket placement table 12 and the bagging table 13 of the self-service POS terminal 10 can be imaged. That is, according to the video obtained in the imaging range including the self-service POS terminal 10, various kinds of merchandise related to the merchandise registration process such as merchandise to be registered at the self-service POS terminal 10 and put in a shopping basket or registered merchandise can be identified.

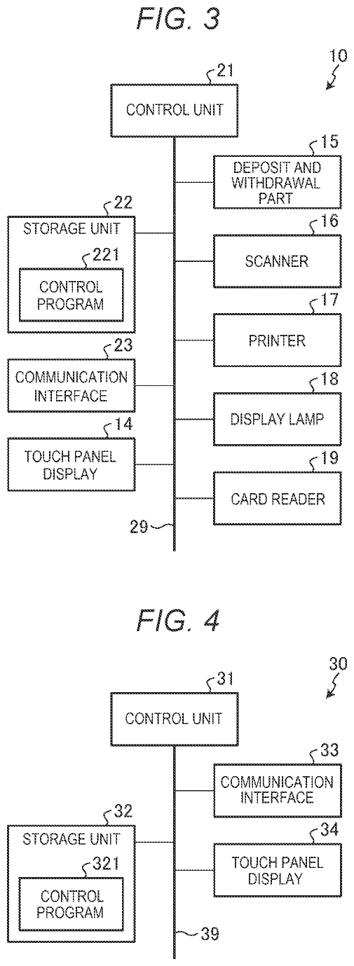

FIG. 3 is a diagram showing an example of a hardware configuration of the self-service POS terminal 10 according to the embodiment. As shown in FIG. 3, the self-service POS terminal 10 includes a touch panel display 14, a deposit and withdrawal part 15, a scanner 16, a printer 17, a display lamp 18, a card reader 19, a control unit 21, a storage unit 22, and a communication interface 23. The touch panel display 14, the deposit and withdrawal part 15, the scanner 16, the printer 17, the display lamp 18, the card reader 19, the control unit 21, the storage unit 22, and the communication interface 23 are connected to one another via a system bus 29 such as a data bus or an address bus.

As shown in FIG. 2, the touch panel display 14 is provided above the scanner 16 on the main body 11. The touch panel display 14 displays various screens and receives an operation performed by the customer.

As shown in FIG. 2, the deposit and withdrawal part 15 is provided in a central portion of the main body 11. The deposit and withdrawal part 15 includes a coin insertion part, a coin discharge part, a bill insertion part, and a bill discharge part. The coin insertion part is an insertion port for receiving a coin being paid by the customer. The coin discharge part is a tray for receiving a coin discharged from the deposit and withdrawal part 15 as change or the like. The bill insertion part is an insertion port for receiving insertion of a bill (paper currency) being paid by the customer. The bill discharge part is a discharge port for a bill discharged from the deposit and withdrawal part 15 as change or the like. For example, when the self-service POS terminal 10 is formed as a cashless terminal that does not handle cash, the deposit and withdrawal part 15 need not be provided.

As shown in FIG. 2, the scanner 16 is provided above the deposit and withdrawal part 15 in the main body 11. As shown in FIG. 2, the scanner 16 includes a reading window 161. The scanner 16 is, for example, a reading device that reads merchandise information from a code symbol such a bar code attached to merchandise held over the reading window 161. In some examples, the scanner 16 reads information from a wireless tag such as a radio frequency (RF) tag (RFID tag). The wireless tag attached to an item of merchandise includes an integrated circuit (IC) chip that stores information and an antenna. The wireless tag transmits tag information stored in the IC chip in response to radio waves received from a wireless tag reading device. For example, the wireless tag stores merchandise information about merchandise to which the wireless tag is attached. The merchandise information may be, for example, a merchandise code that can identify the merchandise.

The scanner 16 may include, for example, a camera implemented to image merchandise held over the reading window 161. The camera of the scanner 16 includes an imaging element such as a CMOS or a CCD. In this case, data of an image of merchandise imaged by the camera of the scanner 16 is subjected to object recognition performed by either the server apparatus 50 or the self-service POS terminal 10. Accordingly, the merchandise included in the image is specified and registered according to object recognition or the like.

The printer 17 is provided inside a housing of the main body 11. The printer 17 is a printing device that prints a receipt showing details of a transaction and/or a coupon on receipt paper or the like. As shown in FIG. 2, the printer 17 includes a receipt discharge part 171. The receipt discharge part 171 is provided between the deposit and withdrawal part 15 and the scanner 16 in the main body 11. The receipt discharge part 171 is a discharge port that discharges a receipt dispensed from the printer 17 or the like to outside of the self-service POS terminal 10.

As shown in FIG. 2, the display lamp 18 is provided behind the touch panel display 14 on the main body 11. The display lamp 18 is an electric light that notifies the salesclerk that an abnormality occurs at the self-service POS terminal 10.

As shown in FIG. 2, the card reader 19 is provided on a side of the scanner 16 in the main body 11. The card reader 19 is a reading device that reads a card such as a credit card.

The control unit 21 is a computer that controls an overall operation of the self-service POS terminal 10 and that implements various functions of the self-service POS terminal 10. The control unit 21 includes a central processing unit (CPU), a read only memory (ROM), and a random access memory (RAM). The CPU is a processor that controls the overall operations of the self-service POS terminal 10. The ROM is a storage medium that stores various programs and data. The RAM is a storage medium that temporarily stores various programs and various kinds of data. The CPU uses the RAM as a work area to execute various programs stored in the ROM, the storage unit 22, or the like.

In some examples, another processor instead of, or in addition to, a CPU may be incorporated in the control unit 21. For example, processing may be performed by hardware such as a graphics processing unit (GPU), an application specific integrated circuit (ASIC), or a field programmable gate array (FPGA) in the control unit 21.

The storage unit 22 is a storage device such as an HDD, an SSD, or a flash memory. The storage unit 22 stores a control program 221. Additionally, a merchandise master file may be stored in the storage unit 22.

The communication interface 23 is an interface for communicating with external apparatuses such as the attendant terminal 30 and the server apparatus 50 via the network N.

FIG. 4 is a diagram showing an example of a hardware configuration of the attendant terminal 30 according to the embodiment. As shown in FIG. 4, the attendant terminal 30 includes a control unit 31, a storage unit 32, a communication interface 33, and a touch panel display 34. The control unit 31, the storage unit 32, the communication interface 33, and the touch panel display 34 are connected to one another via a system bus 39 such as a data bus or an address bus.

The control unit 31 is a computer that controls an overall operation of the attendant terminal 30 and that implements various functions of the attendant terminal 30. The control unit 31 includes a CPU, a ROM, and a RAM. The CPU is a processor that controls the operations of the attendant terminal 30. The ROM is a storage medium that stores various programs and data. The RAM is a storage medium that temporarily stores various programs and various kinds of data. The CPU uses the RAM as a work area to execute various programs stored in the ROM, the storage unit 32, or the like.

Another processor instead of, or in addition to a CPU, may be incorporated into control unit 31. For example, processing in control unit 31 may be performed by a GPU, an ASIC, or an FPGA.

The storage unit 32 is a storage device such as an HDD, an SSD, or a flash memory. The storage unit 32 stores a control program 321.

The communication interface 33 is an interface for communicating with external apparatuses such as the self-service POS terminal 10 and the server apparatus 50 via the network N.

The touch panel display 34 displays various screens and receives an input operation performed by the salesclerk.

FIG. 5 is a diagram showing an example of a hardware configuration of the server apparatus 50 according to the embodiment. As shown in FIG. 5, the server apparatus 50 includes a control unit 51, the storage unit 52, and a communication interface 53. The control unit 51, the storage unit 52, and the communication interface 53 are connected to one another via a system bus 59 such as a data bus or an address bus.

The control unit 51 is a computer that controls an overall operation of the server apparatus 50 and that implements various functions of the server apparatus 50. The control unit 51 includes a CPU, a ROM, and a RAM. The CPU is a processor that controls the operations of the server apparatus 50. The ROM is a storage medium that stores various programs and data. The RAM is a storage medium that temporarily stores various programs and various kinds of data. The CPU uses the RAM as a work area to execute various programs stored in the ROM, the storage unit 52, or the like.

Another processor instead of, or in addition to a CPU, may be incorporated into control unit 51. For example, processing in control unit 51 may be performed by a GPU, an ASIC, or an FPGA.

The storage unit 52 is a storage device such as an HDD, an SSD, or a flash memory. The storage unit 52 stores a control program 521.

The communication interface 53 is an interface for communicating with external apparatuses such as the self-service POS terminal 10, the attendant terminal 30, and the storage apparatus 90 via the network N.

FIG. 6 is a diagram showing an example of a functional configuration of the self-service POS terminal 10 according to the embodiment. A part or all of functions described as implemented by the self-service POS terminal 10 may be implemented in cooperation with the external apparatuses or may be implemented by a hardware configuration such as a dedicated circuit mounted in the self-service POS terminal 10.

The control unit 21 of the self-service POS terminal 10 implements functions of a merchandise registration unit 101, a payment processing unit 102, and a notification unit 103 by executing the control program 221 loaded into the RAM.

The merchandise registration unit 101 registers merchandise to be sold based on the merchandise code read from the wireless tag or the bar code attached to the merchandise. The merchandise registration unit 101 may also or instead register the merchandise to be sold by identifying the merchandise by object recognition based on images captured by a camera of the scanner 16. The merchandise registration unit 101 is not limited to reading the merchandise information, and may also register merchandise as specified by a manual input operation or other means.

The payment processing unit 102 controls a payment process for settling a price related to the merchandise registered by the merchandise registration unit 101. For example, the payment processing unit 102 calculates a total price of merchandise registered by the merchandise registration unit 101. Further, the payment processing unit 102 subtracts the total price from an amount of money inserted into the deposit and withdrawal part 15 to calculate change due. Further, the payment processing unit 102 causes the deposit and withdrawal part 15 to discharge the change.

The notification unit 103 gives an alert (notification) in response to a notification from the attendant terminal 30 or the server apparatus 50. For example, the notification unit 103 notifies fraud detection by causing the touch panel display 14 to display a screen showing the fraud detection, turning on the display lamp 18, changing the light emission color of the display lamp 18, or blinking the display lamp 18.

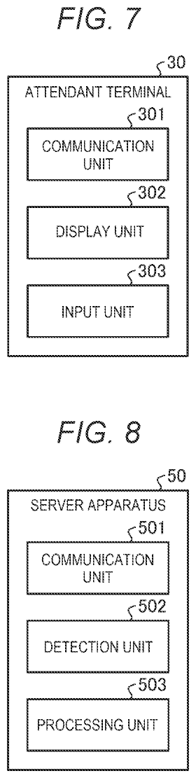

FIG. 7 is a diagram showing an example of a functional configuration of the attendant terminal 30 according to the embodiment. A part or all of functions described as implemented by the attendant terminal 30 may be implemented by cooperation with the external apparatuses or by a hardware configuration such as a dedicated circuit mounted in the attendant terminal 30.

The control unit 31 of the attendant terminal 30 implements functions of a communication unit 301, a display unit 302, and an input unit 303 by executing the control program 321 loaded into the RAM.

The communication unit 301 communicates with the external apparatuses such as the self-service POS terminal 10 and the server apparatus 50 by the communication interface 33.

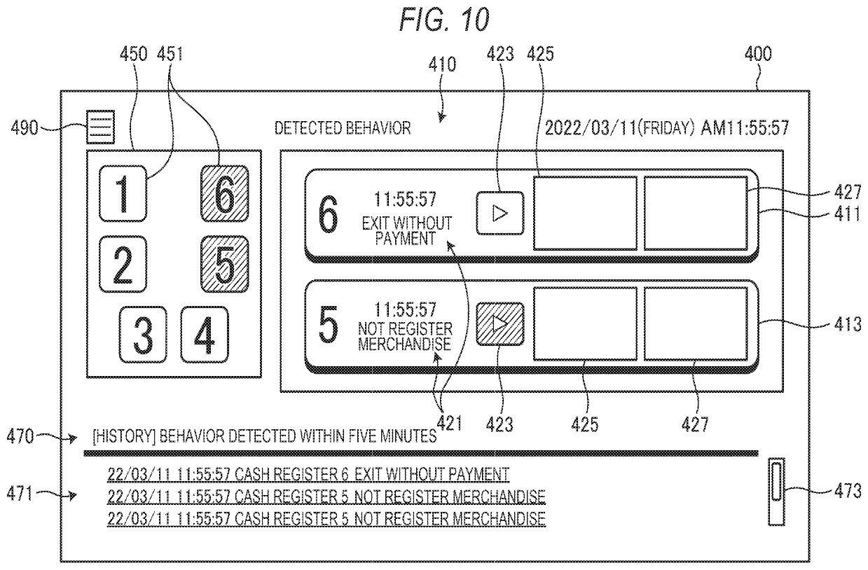

The display unit 302 displays, on the touch panel display 34, a notification screen (see FIG. 10) for notifying the suspected fraud behavior and a reproduction screen for playing a detail confirmation moving image.

The input unit 303 receives an input operation of the salesclerk via the touch panel display 34.

FIG. 8 is a diagram showing an example of a functional configuration of the server apparatus 50 according to the embodiment. A part or all of functions described as implemented by the server apparatus 50 may be implemented in cooperation with external apparatuses or by a hardware configuration such as a dedicated circuit mounted in the server apparatus 50.

The control unit 51 of the server apparatus 50 implements functions of a communication unit 501, a detection unit 502, and a processing unit 503 by executing the control program 521 loaded into the RAM.

The communication unit 501 communicates with the external apparatuses such as the self-service POS terminal 10 and the attendant terminal 30 by the communication interface 53. For example, the communication unit 501 outputs, to the storage apparatus 90, a request notification requesting the data of the video obtained by imaging the self-service POS terminal 10 and the operation position 9. The communication unit 501 also acquires the data of video from the storage apparatus 90. The communication unit 501 outputs simple information (preview information) and detailed information generated by the processing unit 503 to the attendant terminal 30. As an example, the communication unit 501 outputs the simple information to the attendant terminal 30 as soon as the simple information is generated. As an example, when a moving image related to the suspected fraud behavior, that is, the detail confirmation moving image is generated after the simple information is output, the communication unit 501 outputs the detailed information to the attendant terminal 30 once the moving image has been generated. Here, the communication unit 501 according to the embodiment is an example of an acquisition unit and an output unit. Further, the simple information is an example of first notification information or preview information. The detailed information is an example of second notification information.

The detection unit 502 detects the suspected fraud behavior based on the video obtained by imaging the self-service POS terminal 10 and the operation position 9. The detection unit 502 detects the suspected fraud behavior by performing image processing on the video and detecting behaviors of the user and movements of merchandise included in the video. The detection unit 502 may also detect the suspected fraud behavior by using the merchandise information about the merchandise registered at the self-service POS terminal and received from the self-service POS terminal 10.

The processing unit 503 cuts out (clips or extracts) the image related to the suspected fraud behavior, that is, the confirmation image from the video obtained by imaging the self-service POS terminal 10 and the operation position 9. The confirmation image includes at least one of a user confirmation image that is an image for confirming the identity of the operator (user) of the self-service POS terminal 10, and a fraud confirmation image for determining whether the salesclerk should take an additional measure such as calling out to the user in response to the suspected fraud behavior.

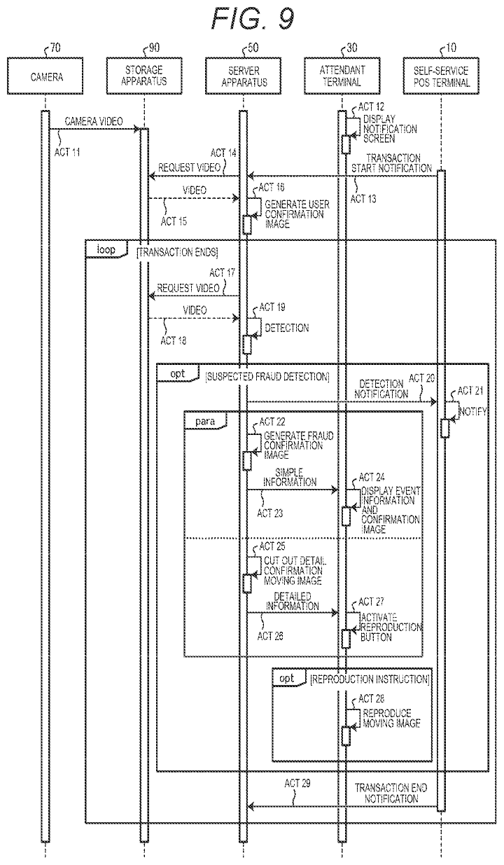

Hereinafter, an operation example of the POS system 1 according to the embodiment will be described with reference to the drawings. FIG. 9 is a sequence diagram showing an example of a flow of information processing executed in the POS system 1 according to the embodiment. The flow in FIG. 9 exemplifies processing performed by any attendant terminal 30 and a self-service POS terminal 10 (hereinafter, the relevant self-service POS terminal 10 is referred to as the target self-service POS terminal 10) from among the plurality of self-service POS terminals 10 monitored by the attendant terminal 30.

The camera 70 captures images in the imaging range including the self-service POS terminal 10 and the operation position 9, and sequentially outputs data of a video obtained by the imaging to the storage apparatus 90 (ACT 11). In this case, the storage apparatus 90 sequentially stores the data of the video from the camera 70. Further, the display unit 302 of the attendant terminal 30 displays a notification screen on the touch panel display 34 (ACT 12).

Thereafter, when a transaction is started at the target self-service POS terminal 10, the self-service POS terminal 10 outputs a transaction start notification to the server apparatus 50 (ACT 13). Further, the self-service POS terminal 10 sequentially transmits, to the server apparatus 50, registered merchandise information and registration information indicating a time thereof. Alternatively, when a suspected fraud behavior is detected from the video, the server apparatus 50 refers to information of the merchandise registered in the self-service POS terminal 10.

The communication unit 501 of the server apparatus 50 requests the data for the relevant video from the storage apparatus 90 in response to the transaction start notification from the self-service POS terminal 10 (ACT 14), and receives the data of the video from the storage apparatus 90 (ACT 15).

The processing unit 503 of the server apparatus 50 cuts out an image including an operator of the self-service POS terminal 10 and generates an image as the user confirmation image (ACT 16). Data of the generated user confirmation image is stored in the storage unit 52 of the server apparatus 50.

Thereafter, in the POS system 1, until the self-service POS terminal 10 issues a transaction end notification (ACT 29), the fraud detection (ACTs 17 to 28) is performed.

The communication unit 501 of the server apparatus 50 requests the data of the video from the storage apparatus 90 (ACT 17), and receives the data of the video from the storage apparatus 90 (ACT 18). Further, the detection unit 502 of the server apparatus 50 starts to detect the suspected fraud behavior by performing image processing on the received video (ACT 19).

When no suspected fraud behavior is detected, acquiring the data of the video by the communication unit 501 and detecting the suspected fraud behavior based on the acquired data of the video are repeated in the server apparatus 50.

On the other hand, when the suspected fraud behavior is detected, the detection unit 502 of the server apparatus 50 outputs a detection notification to the self-service POS terminal 10 (ACT 20). The self-service POS terminal 10 performs notification by using the display lamp 18 or the like in response to the detection notification (ACT 21).

When the suspected fraud behavior is detected, the server apparatus 50 starts to generate both simple information and detailed information. That is, as shown in FIG. 9, the server apparatus 50 generates the simple information and the detailed information in parallel, and but then sequentially outputs the simple information and the detailed information.

Specifically, the processing unit 503 of the server apparatus 50 generates a fraud confirmation image from the video (ACT 22). The processing unit 503 generates the simple information including event information indicating the detected suspected fraud behavior, the user confirmation image, and the fraud confirmation image. At a time point when the simple information has been generated, the processing unit 503 outputs the simple information to the attendant terminal 30 (ACT 23). The attendant terminal 30 updates the notification screen in response to the reception of the simple information, and displays a notification screen 400 (see a notification 411 in FIG. 10) including event information 421, a user confirmation image 425, and a fraud confirmation image 427 (ACT 24).

In parallel with the generation of the simple information, the processing unit 503 of the server apparatus 50 cuts out a part in the video data for which the suspected fraud behavior was detected and includes portions of the preceding and succeeding parts thereof as context to generate a detail confirmation moving image (ACT 25). At a time point when the detail confirmation moving image has been generated, the processing unit 503 outputs the detail confirmation moving image to the attendant terminal 30 as the detailed information (ACT 26). The attendant terminal 30 updates the notification screen 400 (see the notification 413 in FIG. 10) in response to the reception of the detailed information, and activates a reproduction button 423 for instructing the playing (reproduction) of the moving image in the target notification 413 (ACT 27).

The generated detail confirmation moving image may be stored in the storage apparatus 90, and the storage apparatus 90 may be accessed from the attendant terminal 30. In this case, the detailed information may be information that is output from the server apparatus 50 or the storage apparatus 90 to the attendant terminal 30 at a time point at which the generation of the detail confirmation moving image and an upload to the storage apparatus 90 are ended and that indicates that a state where the detail confirmation moving image can be reproduced is established.

In some examples, server apparatus 50 may sequentially output cut-out frames (extracted frames) as the detail confirmation moving image. That is, the detail confirmation moving image is not limited to a case of being output from the server apparatus 50 to the attendant terminal 30 as a moving image file that can itself be played, but may be output from the server apparatus 50 to the attendant terminal 30 as data that can constitute a moving image file once combined. In this case, the detailed information may be information that is output once all data that constitutes the detail confirmation moving image has been output and a state where the detail confirmation moving image can be played is established.

For example, when the salesclerk presses or otherwise selects the reproduction button 423 via the touch panel display 34 by the input unit 303, the display unit 302 of the attendant terminal 30 displays the detail confirmation moving image on the touch panel display 34 (ACT 28).

Thereafter, when the transaction is ended at the target self-service POS terminal 10, the self-service POS terminal 10 outputs the transaction end notification to the server apparatus 50 (ACT 29), and the flow in FIG. 9 is ended.

FIG. 10 is a diagram showing an example of the notification screen 400 displayed in the information processing according to an embodiment. The notification screen 400 exemplified in FIG. 10 includes a detected suspected fraud behavior display 410, a map display 450 showing the position of the self-service POS terminal 10 where the suspected fraud behavior is detected, a history display 470 of the detected suspected fraud behavior, and a menu display 490.

The detected suspected fraud behavior display 410 includes a notification 411 and a notification 413 for detection of multiple instances of suspected fraud behavior, that is, for each occurrence of an incident. FIG. 10 includes the notification 411 corresponding to detection of an exit without payment and the notification 413 corresponding to a detection of unregistered merchandise. Each of the notifications 411 and 413 includes the event information 421, the reproduction button 423, and the confirmation images 425 and 427.

The map display 450 shows the self-service POS terminal 10 after the suspected fraud behavior is detected. The notification screen 400 in FIG. 10 exemplifies a case where the suspected fraud behavior was detected in the self-service POS terminals 10 labeled as “5” and “6”.

The history display 470 of the suspected fraud behavior can be a list indicating history of the suspected fraud behavior as detected within a predetermined preceding amount of time or the like. The notification screen 400 in FIG. 10 exemplifies a case where two pieces of suspected fraud behavior of “not registering merchandise” at the self-service POS terminal 10 of “5” and one piece of suspected fraud behavior of “exit without payment” at the self-service POS terminal 10 of “6” were detected within the preceding five minutes. An event to be displayed on the history display 470 is not limited to an event detected within five minutes, and can be any event detected within any predetermined length of time. Further, in the history display 470, an event displayed by a slider 473 can be scrolled.

The menu display 490 is expanded by being selected or the like. Various settings can be made from an expanded tab, and a screen and the like that displays a video obtained by imaging the current self-service POS terminal 10 can be transitioned to another display screen.

As an example, the notification 411 corresponding to the detection of the exit without payment includes the event information 421 indicating that the suspected fraud behavior of “exit without payment” was detected at “11:55:57” at the self-service POS terminal 10 of “6”. Further, the notification 411 includes the reproduction button 423.

As an example, the notification 413 corresponding to the detection of not registering merchandise includes the event information 421 indicating that the suspected fraud behavior of “not registering merchandise” was detected at “11:55:57” at “5” indicating the number of the particular self-service POS terminal 10. The notification 413 includes the reproduction button 423.

The notification 411 exemplifies a display mode before the detailed information was received. That is, the notification 411 is in a state where the detail confirmation moving image cannot yet be reproduced. On the other hand, the notification 413 exemplifies a display mode after the detailed information has been received. That is, the notification 413 is in a state where the detail confirmation moving image can be reproduced. For example, as exemplified in FIG. 10, the reproduction button 423 of the notification 411 is in a grayed-out display state indicating that an operation is presently deactivated, and it is possible to determine from the display that the moving image cannot yet be reproduced at present.

The display mode of the reproduction button 423 before the detailed information is received is not limited to a case of being grayed out. Any change is possible as long as the reproducible state and the non-reproducible state can be determined from the display. For example, a display mode in which a highlighted display indication such as blinking is performed when in the reproducible state may be used, a display mode in which display colors are different in the states may be used, or a display mode in which a three-dimensional display is performed with a shadow in the reproducible state may be used.

The confirmation images 425 and 427 serving as images related to the suspected fraud behavior are displayed in each of the notifications 411 and 413.

As an example, the image related to the suspected fraud behavior is at least any one of the user confirmation image 425 and the fraud confirmation image 427. The notification screen 400 in FIG. 10 exemplifies a case where both the user confirmation image 425 and the fraud confirmation image 427 are displayed.

The user confirmation image 425 is, for example, an image at a transaction start time point. The user confirmation image 425 may be generated by playing back the video, and searching for and cutting out a part including the user by using, for example, person detection (identification) such as face detection when the suspected fraud behavior was detected.

The fraud confirmation image 427 is an image from which it can be determined whether the suspected fraud behavior is actually (or substantially likely to be) fraud behavior. Specifically, the fraud confirmation image 427 is an image serving as a determination material for determining whether the salesclerk takes a measure such as calling out to the user in response to the suspected fraud behavior. The fraud confirmation image 427 is, for example, an image corresponding to a type of the detected suspected fraud behavior.

As an example, the fraud confirmation image 427 corresponding to an exit without payment event is an image obtained by cutting out a timing at which no user exists at the operation position 9.

As an example, the fraud confirmation image 427 corresponding to the exit without payment event is an image obtained by cutting out a timing at which the user leaves from the operation position 9.

As an example, the fraud confirmation image 427 corresponding to the exit without payment event is an image obtained by cutting out a timing tracing back by a predetermined time after the exit without payment is detected.

As an example, the fraud confirmation image 427 corresponding to a not registering merchandise event is an image including merchandise moved toward the bagging table 13 without being registered.

As an example, the fraud confirmation image 427 corresponding to the not registering merchandise event is an image obtained by cutting out a timing at which merchandise is moved toward the bagging table 13 without being registered.

As an example, the fraud confirmation image 427 corresponding to the not registering merchandise event is an image obtained by cutting out a timing at which the merchandise moved toward the bagging table 13 without being registered is taken out from the basket or the basket placement table 12.

As an example, the fraud confirmation image 427 corresponding to the not registering merchandise event is an image obtained by cutting out the basket placement table 12 or the basket placed on the basket placement table.

As described above, in the POS system 1 according to the embodiment, the notification screen 400 for notifying the store staff displays the image simultaneously related to the suspected fraud event information describing the type of the fraud together with the suspected fraud event information. Accordingly, the store staff can determine whether to take a measure such as calling out to the user of the self-service POS terminal 10 by viewing the fraud detection event (text) information and the image. Further, since the notification screen 400 can be displayed even during the generation of the detail confirmation moving image, a time from occurrence of an incident to notification can be reduced, and a risk of missing a timing for taking a measure such as calling out can be reduced.

In the POS system 1 according to the embodiment, for a case where a determination cannot be made only with the text information and the image, it is possible to cut out and reproduce the detail confirmation moving image related to behavior suspected to be fraudulent. The moving image is shared by the store staff after the suspected fraud event. Since a little time is required until the moving image can be reproduced, the store staff uses the moving image when the store staff wants to confirm details. Accordingly, when the suspected fraud behavior is detected, it is possible to promptly notify the store staff of necessary information. Further, for a situation where the detailed information is necessary, by sharing the moving image when behavior is determined as fraud, it is possible to assist in a correct determination performed by the store staff. For example, the store staff can also confirm the detail confirmation moving image, or confirm a display state of the LED turned on during the merchandise registration.

In the embodiment described above, for example, as exemplified in FIG. 1, one attendant terminal 30 corresponding to the self-service POS terminal group including the two self-service POS terminals 10 is exemplified, but the exemplary embodiment is not limited thereto. The number of the self-service POS terminals 10 corresponding to one attendant terminal 30 may be three or more. Further, the POS system 1 may include a plurality of attendant terminals 30 and the self-service POS terminal groups corresponding to the plurality of attendant terminals 30. Further, at least one attendant terminal 30 among the plurality of attendant terminals 30 may be a semi-self-service-type POS terminal.

The technique according to the embodiment can also be applied to other sales data processing apparatuses of the self-service POS terminal 10, such as the semi-self-service-type POS terminal for the shopper who is the operator to perform the settlement after the merchandise registration performed by the salesclerk, and a POS terminal for the salesclerk who is the operator to perform the merchandise registration and the settlement.

For example, when the technique according to the embodiment is applied to the semi-self-service-type POS terminal, display to be described later may be performed in the POS terminal in which the salesclerk performs the merchandise registration, or may be performed in the attendant terminal 30 for managing at least one semi-self-service-type POS terminal.

For example, when the technique according to the embodiment is applied to the POS terminal for the salesclerk who is the operator to perform the merchandise registration and the settlement, the display to be described later may be performed in the POS terminal operated by the salesclerk, or may be performed in a management terminal disposed in the backroom or the like.

When the notification screen 400 is displayed on the POS terminal used by the operator (user) who is the detection target of the suspected fraud behavior, the reproduction button 423 of the detail confirmation moving image, the map display 450, and the history display 470 of another POS terminal may not be displayed.

A case where the detail confirmation moving image is reproduced in response to the activated reproduction button 423 being selected on the notification screen 400 is exemplified, but the exemplary embodiment is not limited thereto. The detail confirmation moving image may have a specification in which the detail confirmation moving image can be reproduced, that is, the detail confirmation moving image is reproduced once the detailed information is received.

Unconfirmed items may be highlighted, or status information such as confirmed, unconfirmed, handled, and unhandled states may be further displayed on the suspected fraud behavior display 410 and the history display 470.

As described above, according to the embodiment, it is possible to appropriately notify occurrence of an incident on the POS terminal.

The control programs executed by the apparatuses of the POS system 1 according to the present embodiment are provided by being incorporated in advance in the ROM or the like.

The control programs executed by the apparatuses of the POS system 1 according to the present embodiment may be provided by being recorded in a computer-readable recording medium such as a CD-ROM, a flexible disk (FD), a CD-R, or a digital versatile disk (DVD) as files having an installable form or an executable form.

The control programs executed by the apparatuses of the POS system 1 according to the present embodiment may be stored in a computer connected to a network such as the Internet and provided by being downloaded via the network. Further, the control programs executed by the apparatuses of the POS system 1 according to the present embodiment may be provided or distributed via the network such as the Internet.

The control program 221 executed by the self-service POS terminal 10 according to the present embodiment has a module configuration including the units described above (the merchandise registration unit 101, the payment processing unit 102, and the notification unit 103). The CPU (processor) reads the control program 221 from the storage medium described above, and loads the units described above into a main memory device. Accordingly, the merchandise registration unit 101, the payment processing unit 102, and the notification unit 103 are generated in the main memory device.

The control program 321 executed by the attendant terminal 30 according to the present embodiment has a module configuration including the units described above (the communication unit 301, the display unit 302, and the input unit 303). The CPU (processor) reads the control program 321 from the storage medium described above, and loads the units described above into the main memory device. Accordingly, the communication unit 301, the display unit 302, and the input unit 303 are generated in the main memory device.

The control program 321 executed by the server apparatus 50 according to the present embodiment has a module configuration including the units described above (the communication unit 501, the detection unit 502, and the processing unit 503). The CPU (processor) reads the control program 321 from the storage medium described above, and loads the units described above into the main memory device. Accordingly, the communication unit 501, the detection unit 502, and the processing unit 503 are generated in the main memory device.

Although certain exemplary embodiments are described, these embodiments are presented as examples only, and are not intended to limit the scope of the exemplary embodiments. These novel embodiments can be implemented in various other forms, and various omissions, substitutions, and changes can be made without departing from the spirit of the exemplary embodiments. The accompanying claims and their equivalents are intended to cover such forms or modifications as would fall within the scope and spirit of the exemplary embodiments.

What is claimed is:

1. An information processing apparatus for retail store systems, the apparatus comprising:
a communication interface connected to a camera positioned to acquire video of a POS terminal and an operation position for an operator of the POS terminal; and
a processor configured to:
detect suspected fraud behavior of the operator at the POS terminal based on image analysis of the acquired video;
generate a first notification indicating a type of detected suspected fraud behavior and including an image related to the suspected fraud behavior, the image being extracted from the acquired video at a time point corresponding the detected suspected fraud behavior;
output the generated first notification via the communication interface to a display unit;
generate a second notification including a video clip extracted from the acquired video at the time point corresponding to the detected suspected fraud behavior; and
output the second notification via the communication interface to the display unit after the first notification.

2. The information processing apparatus according to claim 1, wherein the processor is configured to generate the first notification and the second notification in parallel.

3. The information processing apparatus according to claim 1, wherein the image related to the suspected fraud behavior includes a representation of the operator.

4. The information processing apparatus according to claim 1, wherein the communication interface is connected to an attendant terminal.

5. The information processing apparatus according to claim 4, wherein the first and second notifications are output to the attendant terminal including the display unit.

6. The information processing apparatus according to claim 1, wherein the image related to the suspected fraud behavior includes an image of a shopping basket at the POS terminal.

7. The information processing apparatus according to claim 1, wherein the processor is configured to receive transaction information from the POS terminal via the communication interface.

8. The information processing apparatus according to claim 7, wherein the received transaction information is used in detecting the suspected fraud behavior.

9. The information processing apparatus according to claim 1, wherein the suspected fraud behavior includes leaving the POS terminal without paying.

10. The information processing apparatus according to claim 1, wherein the suspected fraud behavior includes not registering an item of merchandise at the POS terminal.

11. An information processing system, comprising:
a point-of-sale (POS) terminal connected to a communication network;
a camera connected to the communication network and positioned to acquire video of the POS terminal and an operation position for an operator of the POS terminal;
a display unit connected to the communication network; and
an information processing apparatus including:
a communication interface connected to the communication network; and
a processor configured to:
detect suspected fraud behavior of the operator at the POS terminal based on image analysis of the acquired video;
generate a first notification indicating a type of detected suspected fraud behavior and including an image related to the suspected fraud behavior, the image being extracted from the acquired video at a time point corresponding the detected suspected fraud behavior;
output the generated first notification via the communication interface to the display unit;
generate a second notification including a video clip extracted from the acquired video at the time point corresponding to the detected suspected fraud behavior; and
output the second notification via the communication interface to the display unit after the first notification.

12. The information processing system according to claim 11, wherein the processor is configured to generate the first notification and the second notification in parallel.

13. The information processing system according to claim 11, wherein the display unit displays the first notification in conjunction with event information, the image related to the suspected fraud behavior, and a reproduction button configured to instruct reproduction of the moving image.

14. The information processing system according to claim 13, wherein the reproduction button is in a display state indicating that operation is deactivated until the second notification is received.

15. The information processing system according to claim 11, wherein the display unit is included in an attendant terminal.

16. The information processing system according to claim 11, wherein the suspected fraud behavior includes not registering an item of merchandise at the POS terminal.

17. An information processing method, comprising:
acquiring a video obtained by imaging a POS terminal and an operation position of an operator at the POS terminal;
detecting suspected fraud behavior based on the acquired video;
generating a first notification indicating a type of suspected fraud behavior and including an image related to the suspected fraud behavior, the image being extracted from the acquired video at a time point corresponding to the suspected fraud behavior;
outputting the generated first notification;
generating a second notification including a video clip extracted from the acquired video at the time point corresponding to the detected suspected fraud behavior; and
outputting the second notification via the communication interface to the display unit after the first notification.

18. The information processing method according to claim 17, wherein the first notification and the second notification are generated in parallel.

19. The information processing method according to claim 17, wherein the image related to the suspected fraud behavior includes a representation of the operator.

20. The information processing method according to claim 17, wherein the suspected fraud behavior includes not registering an item of merchandise at the POS terminal.
